(19) United States
(12) Patent Application Publication
(10) Pub. No.: US 2009/0251007 A1
(43) Pub. Date: Oct. 8, 2009

(54) Hot-Swappable Battery Retrofit Module

(76) Inventors: William L. Adams, Powell, OH (US); Mark Hamilton, Upton, MA (US)

Correspondence Address: THERMO FINNIGAN LLC, 355 RIVER OAKS PARKWAY, SAN JOSE, CA, 95134, US

(21) Appl. No.: 12/406,801

(22) Filed: Mar. 18, 2009

Related U.S. Application Data
(60) Provisional application No. 61/043,098, filed on Apr. 7, 2008.

(51) Int. Cl. H02J 3/00; H02J 7/00

(52) U.S. Cl. 307/70; 307/80; 320/103

(57) ABSTRACT

A retrofit module electrically connects to a device's battery terminals, where an original main battery would otherwise connect to the device, and a hot-swappable battery electrically connects to the retrofit module, thereby retrofitting the device for operation with hot-swappable batteries, without shutting down the device to swap the batteries. When a charged hot-swappable battery is connected to the retrofit module, the retrofit module powers the device from the hot-swappable battery. The retrofit module includes a bridge battery and a circuit that charges the bridge battery from the hot-swappable battery and that provides power to the device from the bridge battery while the hot-swappable battery is replaced. The retrofit module may include a releasable structure that maintains the module in contact with the device's battery terminals, even after the hot-swappable battery has been removed. The retrofit module may have a form factor and power supplying terminals similar to those of the main battery that the device is configured to accept.

### CROSS REFERENCE TO RELATED APPLICATIONS

This application claims the benefit of U.S. Provisional Patent Application No. 61/043,098, filed Apr. 7, 2008, titled “Hot-Swappable Battery Retrofit Module,” the entire contents of which are hereby incorporated by reference herein, for all purposes.

### TECHNICAL FIELD

The present invention relates to hot-swappable battery circuits and, more particularly, to such circuits that may be used to retrofit a device that does not originally have a battery hot-swap capability.

### BACKGROUND ART

Many test instruments, laptop computers and other portable electrical and electronic devices are powered by batteries which, of course, have limited capacities to provide electrical power, after which they must be recharged or replaced with fresh, or freshly recharged, batteries. Absent some special arrangement to provide power to a device while a battery is replaced, the device must be shut down during the battery replacement operation. Such a shut down may be undesirable. For example, a test instrument may loose calibration, certification and/or user-entered parameters upon being shut down and, therefore, require a lengthy recalibration, recertification and/or setup procedure, once the device receives a charged battery and is powered up. The recalibration, recertification and/or setup procedure necessarily consumes time and some of the newly-inserted battery's power, thereby reducing a user's efficiency and the amount of time the battery can power the device for productive uses.

Furthermore, if a test instrument's battery becomes exhausted and needs to be replaced in the middle of a lengthy experiment, during the battery replacement the test instrument may loose data that had been collected up to the time the battery became exhausted and, consequently, the experiment may have to be restarted. Restarting an experiment may pose problems, particularly if the experiment involves destructive testing, because most or all of a test sample may have been destroyed during the first portion of the experiment, leaving an insufficient amount of test sample to conduct the entire experiment from the beginning.

Some electronic devices include two equal-sized main battery slots, permitting one of the main batteries to be replaced at a time, while continuing to operate the device from the other main battery. Such an arrangement enables essentially continuous operation of the devices by alternatingly replacing the batteries. However, such devices require circuits that draw power preferentially from one of the two batteries until that battery is exhausted, and then automatically draw power from the other of the two batteries while the exhausted battery is replaced. Furthermore, such an arrangement requires too much space, and may involve too much weight, for small, hand-held test instruments.

Some electronic devices include “bridge” battery backup circuits that provide power to the devices for short periods of time, typically only a few minutes, while exhausted batteries are replaced. For example, a MAX1612 integrated circuit (available from Maxim Integrated Products, Inc., Sunnyvale, Calif.) or a LTC1558 integrated circuit (available from Linear Technology Corporation, Milpitas, Calif.) enables a device to be powered by a separate, dedicated auxiliary or backup bridge battery while a main battery is replaced. Some available circuits recharge the bridge battery, once the exhausted main battery has been replaced with a charged battery. In some cases, the device must enter a low power consuming state while the main battery is replaced.

Unfortunately, devices that do not include multiple full-size main battery slots or bridge battery backup circuits and dedicated bridge batteries must be shut down whenever their main batteries are replaced.

### SUMMARY OF THE INVENTION

An embodiment of the present invention provides a hot-swap battery retrofit module that may be used in a battery-powered device, such as a test instrument, laptop computer, toxic gas warning device, flashlight or the like. The hot-swap battery retrofit module may be connected to battery terminals of the device. The battery terminals of the device are typically compatible with terminals on one or more batteries (for simplicity, collectively herein referred to as a first battery). The hot-swap battery retrofit module includes a plurality of electric power receiving terminals that are compatible with terminals on one or more batteries (for simplicity, collectively herein referred to as a second battery). The first battery may be the same type as the second battery, or the first and second batteries may be of different types. For example, the configuration of the terminals on the first battery may be configured in substantially the same manner as the terminals on the second battery, or the terminals on the first battery may be configured differently than the terminals on the second battery.

The hot-swap battery retrofit module also includes a plurality of electric power supplying terminals that are compatible with the battery terminals of the device. In use, the hot-swap battery retrofit module is disposed so the power supplying terminals are in contact with the battery terminals of the device. The hot-swap battery retrofit module also includes an energy storage device and a circuit connected to the energy storage device, the power receiving terminals and the power supplying terminals. In a first mode, the power receiving terminals are coupled to the power supplying terminals, and in a second mode, the energy storage device is coupled to the power supplying terminals.

In an example of the first mode, while a charged battery is connected to the hot-swap battery retrofit module, the circuit routes power from the battery, via the power receiving terminals and the power supplying terminals, to the device. However, in an example of the second mode, while the battery is being swapped, the circuit routes power from the energy storage device, via the power supplying terminals, to the device. The circuit may be configured to charge the energy storage device from power available via the power receiving terminals, i.e., from the battery connected to the power receiving terminals.

The mode may be determined based on whether or not a battery is coupled to the power receiving terminals or whether or not a battery having at least a predetermined level of charge is coupled to the power receiving terminals. Thus, in one embodiment, in the first mode, a battery is coupled to the power receiving terminals and in the second mode no battery is coupled to the power receiving terminals. In another embodiment, in the first mode, a battery having at least a predetermined level of charge is coupled to the power receiving terminals, and in the second mode no battery or a battery having less than the predetermined level of charge is coupled to the power receiving terminals.

At least a portion of the retrofit module may have a form factor based on at least a portion of a form factor of the first battery, i.e., a battery with which the battery terminals of the device are compatible. For example, the portion of the module having the power supplying terminals may have a form factor similar to the portion of the first battery where the battery terminals are located.

In one embodiment, the hot-swap battery retrofit module includes a substrate, and the plurality of electric power receiving terminals and the plurality of electric power supplying terminals are disposed on the substrate. The substrate may, but need not, be thin enough to fit between the terminals of the battery and the battery terminals of the device, so that the original main battery may be used for a hot-swappable battery. The module may include a housing separate from the substrate, and the circuit may be disposed in the housing. A cable may connect the circuit to the power receiving terminals and to the power supplying terminals.

The hot-swap battery retrofit module may include a retaining structure configured to maintain at least the power supplying terminals of the module in contact with the device's battery terminals, even if the main battery is removed from the device. The retaining structure may be releasable. For example, the retaining structure may include a resilient friction material on at least a portion of a surface of the retrofit module or otherwise proximate the surface of the retrofit module. The retaining structure may include an expandable structure, such as a structure that is small enough to be inserted into a battery compartment and then may be expanded to mechanically engage, such as by friction, at least a portion of the battery compartment. The retaining structure may include a structure capable of at least partial rotation, such as a cam or other eccentric structure that, when rotated, engages (such as by pressing against or by entering a recess of) a portion of the battery compartment. In other embodiments, the retaining structure may be permanent, such as an adhesive, a frangible structure or a mechanical interlock with a structure within the battery compartment.

The hot-swap battery retrofit module may include a port for accepting a removal tool and by which the retrofit module may be removed from contact with the device's battery terminals. For example, the tool may be used to expand the expandable structure or rotate the at least partially rotatable structure described above. Furthermore, the tool may be used to pull on the module with a force sufficient to overcome friction that may be maintaining the module in place.

The hot-swap battery retrofit module may include an index structure that cooperates with a structure of the device to limit orientation of the retrofit module within a battery compartment of the device. The index structure may include a boss, ridge, groove or the like or a combination thereof. The index structure may facilitate disposing the module so the power supplying terminals come into, and/or remain in, proper contact with the battery terminals of the device.

The energy storage device may be one or more rechargeable batteries (collectively a battery) and/or one or more capacitors (collectively a capacitor).

Another embodiment of the present invention provides a method for providing temporary electrical power to a device while a battery is replaced. A hot-swap battery retrofit module is interposed between battery terminals of the device and terminals on the battery, such that at least one of the terminals of the battery is not in physical and direct electrical contact with any battery terminal of the device. (In this context, “direct electrical contact” means the terminal on a battery touches a battery terminal of the device, so current can flow therebetween.) Electrical power is supplied from the hot-swap battery retrofit module to the battery terminals of the device while the battery is being replaced.

During battery replacement, terminals of a replacement battery may be connected to the hot-swap battery retrofit module, such that at least one of the terminals of the replacement battery is not in physical and direct electrical contact with any battery terminal of the device. Once the replacement battery is installed, electrical power may be supplied from the replacement battery to the battery terminals of the device.

The hot-swap battery retrofit module may be interposed between battery terminals of the device and terminals on the battery by disposing a plurality of power receiving terminals in physical and direct electrical contact with the terminals on the battery and disposing a plurality of power supplying terminals in physical and direct electrical contact with the battery terminals of the device. In addition, a circuit that includes an energy storage device and that is coupled to the power receiving and power supplying terminals is provided. Once the module is interposed, the electrical power may be supplied while the battery is being replaced by supplying electrical power from the energy storage device via the power supplying terminals.

In addition, terminals of a replacement battery may be connected to the power receiving terminals, such that at least one of the terminals of the replacement battery is not in physical and direct electrical contact with any battery terminal of the device.

Optionally, the energy storage device may be charged from a battery connected to the power receiving terminals, i.e., the replacement battery.

### BRIEF DESCRIPTION OF THE DRAWINGS

The invention will be more fully understood by referring to the following Detailed Description of Specific Embodiments in conjunction with the Drawings, of which:

FIG. 1 is a perspective view of an exemplary prior art non-hot-swappable battery-powered device;

FIG. 2 is a perspective view of an exemplary prior art battery that may be used with the device of FIG. 1;

FIG. 3 is a perspective cut-away view of the device of FIG. 1, showing the battery of FIG. 2 installed in the device;

FIGS. 4 and 5 are perspective views showing top and bottom portions, respectively, of a retrofit module that may be used with the device of FIG. 1, according to an embodiment of the present invention;

FIG. 6 is a perspective view of an exemplary hot-swappable battery that may be used with the retrofit module of FIGS. 4 and 5 and the device of FIG. 1, according to an embodiment of the present invention;

FIG. 7 is a perspective cut-away view of the device of FIG. 1, showing the retrofit module of FIGS. 4 and 5 and the battery of FIG. 6 installed in the device, according to an embodiment of the present invention;

FIG. 8 is a schematic block diagram of a circuit in the retrofit module of FIGS. 4 and 5, according to an embodiment of the present invention;

FIG. 9 is a schematic diagram of the retrofit module of FIGS. 4 and 5, according to another embodiment of the present invention;

FIG. 10 is a schematic block diagram of the retrofit module of FIGS. 4 and 5, according to yet another embodiment of the present invention;

FIG. 11 is a perspective cut-away view of the device of FIG. 1, showing a retrofit module and the battery of FIG. 2 installed in the device, according to another embodiment of the present invention; and

FIG. 12 is a flowchart that illustrates operations that may be performed to provide temporary electrical power to a device while a battery is replaced, according to an embodiment of the present invention.

### DETAILED DESCRIPTION OF SPECIFIC EMBODIMENTS

In accordance with embodiments of the present invention, methods and apparatus are disclosed for retrofitting a battery-operated electrical or electronic device to support hot-swapping of the device's main battery, without shutting down the device. A retrofit module electrically connects to the device's battery terminals, where the original main battery would otherwise connect to the device, and a hot-swappable battery electrically connects to the retrofit module. When a charged hot-swappable battery is connected to the retrofit module, the retrofit module powers the device from the hot-swappable battery. The retrofit module includes a bridge battery and a circuit that charges the bridge battery from the hot-swappable battery and that provides power to the device from the bridge battery while the hot-swappable battery is replaced.

The retrofit module may include a structure that releasably maintains the module in contact with the device's battery terminals, even after the hot-swappable battery has been removed. When the retrofit module, with a charged bridge battery, is installed, the device may be operated as though a main battery had been installed, whether a hot-swappable battery is installed or not. Thus, the hot-swappable batteries may be replaced sequentially, and the device may be operated continuously, for any desired length of time, without shutting down the device when a hot-swappable battery needs to be replaced.

The retrofit module may have a form factor similar to all or a portion of the main battery that the device is configured to accept (the “original main battery”). In some embodiments, at least a portion of the retrofit module has a form factor similar to the portion of the original main battery that includes one or more of the original main battery's terminals. The retrofit module includes power supplying terminals that are compatible with the device's battery terminals. In use, the retrofit module is installed adjacent the device's battery terminals, so the power supplying terminals of the retrofit module make electrical and mechanical contact with the device's battery terminals, substantially the same way terminals on the original main battery would make electrical contact with the device's battery terminals, if the original main battery were used. All or part of the retrofit module may occupy some or all of the space that would otherwise be occupied by the device's original main battery.

After the retrofit module has been installed, a hot-swappable battery that is physically smaller than the original main battery may be required, because the retrofit module may occupy some of the space that had been reserved for the device's original main battery. The smaller hot-swappable battery may store less energy than the original main battery and may, therefore, have to be replaced more frequently than the original main battery. However, such a small hot-swappable battery is likely to be lighter in weight than the original main battery, making the device lighter and easier to use. Furthermore, with the retrofit module installed in the device, the hot-swappable battery may be replaced quickly, with no time lost to recalibration, recertification, setup procedures, etc. In addition, the hot-swappable battery may be replaced in the middle of an experiment, with no loss of data.

Rechargeable batteries may be used as the hot-swappable batteries. That is, exhausted rechargeable batteries may be removed from the device, recharged and later used to replace other exhausted batteries. Optionally or alternatively, non-rechargeable batteries may be used sequentially to operate the device. Rechargeable and non-rechargeable batteries may be alternated, e.g., a rechargeable battery may be replaced by a non-rechargeable batter and vice versa, although typically rechargeable and non-rechargeable batteries should not be used concurrently, due to differences in their voltage and current discharge profiles.

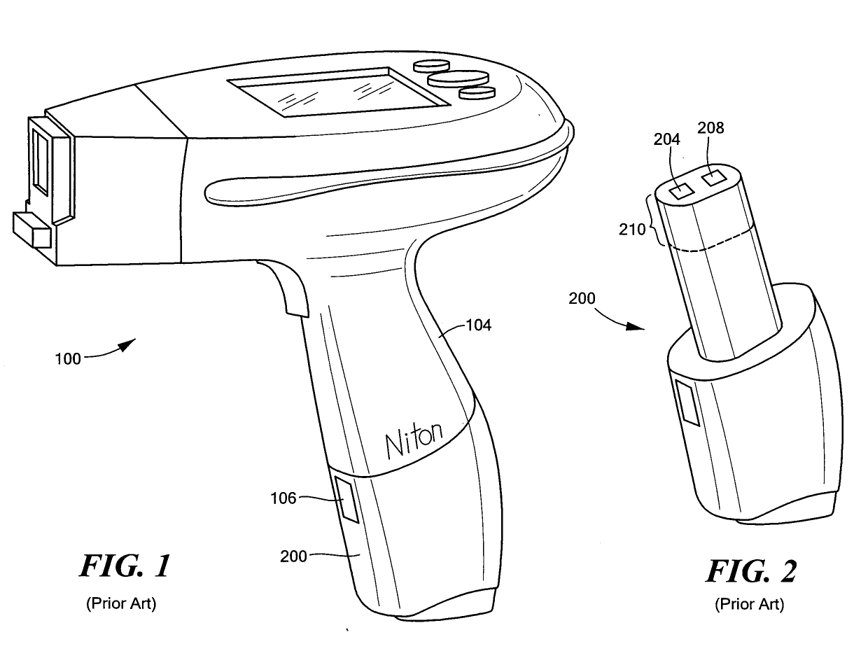

FIG. 1 is a perspective view of an exemplary prior art non-hot-swappable battery-powered device 100 that may be retrofitted with a module, as described herein, and thus converted to support hot-swapping of batteries. The exemplary device 100 may be a hand-held, self-contained x-ray fluorescence (XRF) analyzer, a hand-held, self-contained optical emission spectroscopy (OES) analyzer or any other type of device that is powered by a battery.

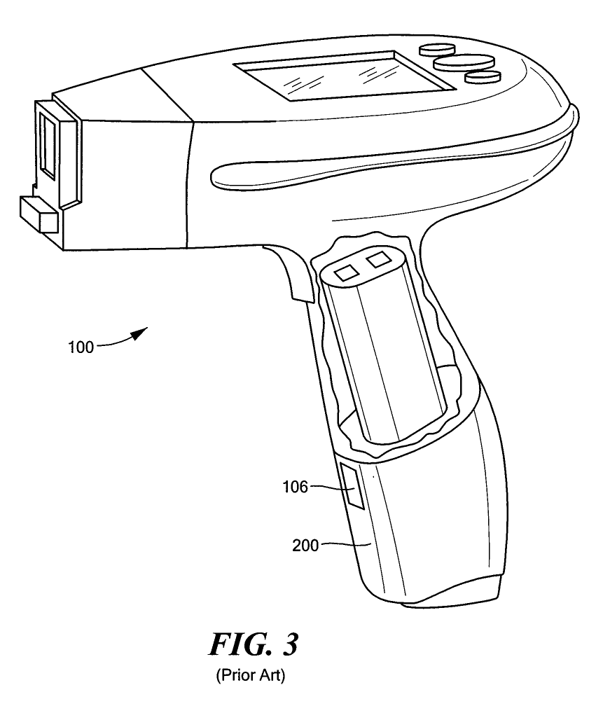

FIG. 2 is a perspective view of an exemplary prior art battery assembly 200 that may be attached to the device 100. For example, the battery assembly 200 may be inserted into a hollow portion of the handle 104 of the device 100, as shown in FIG. 3. Hidden portions of the battery assembly 200 are shown in phantom in FIG. 3. The battery assembly 200 and the device 100 may have cooperating mechanisms (not shown) for latching the battery assembly 200, once the battery assembly 200 is fully inserted into the handle 104. The battery assembly 200 may include a release button 106 that, when actuated, releases the latching mechanisms, so the battery assembly 200 may be withdrawn from the handle 104. Optionally or alternatively, the release button may be located on the handle 104 or elsewhere on the device 100 or elsewhere on the battery assembly 200. Although a monolithic battery assembly 200 is shown, optionally or alternatively, one or more individual replaceable batteries or cells (not shown) may be inserted into the battery assembly 200. Similarly, rather than using a battery assembly 200, one or more individual battery cells (and an optional battery compartment cover) may be used.

Returning to FIG. 2, the battery assembly 200 includes two battery terminals 204 and 208 that make contact with battery terminals (not shown) in the device 100. For example, the battery terminals of the device 100 may be resilient metal contacts, against which the terminals 204 and 208 of the battery assembly 200 are pressed, when the battery assembly 200 is inserted into the handle 104 of the device 100. The form factor of the battery assembly 200 may be custom designed for the device 100, to which the battery assembly 200 is to be connected. In other contexts, standard form factor batteries, such as cylindrical or other shaped batteries, may be used.

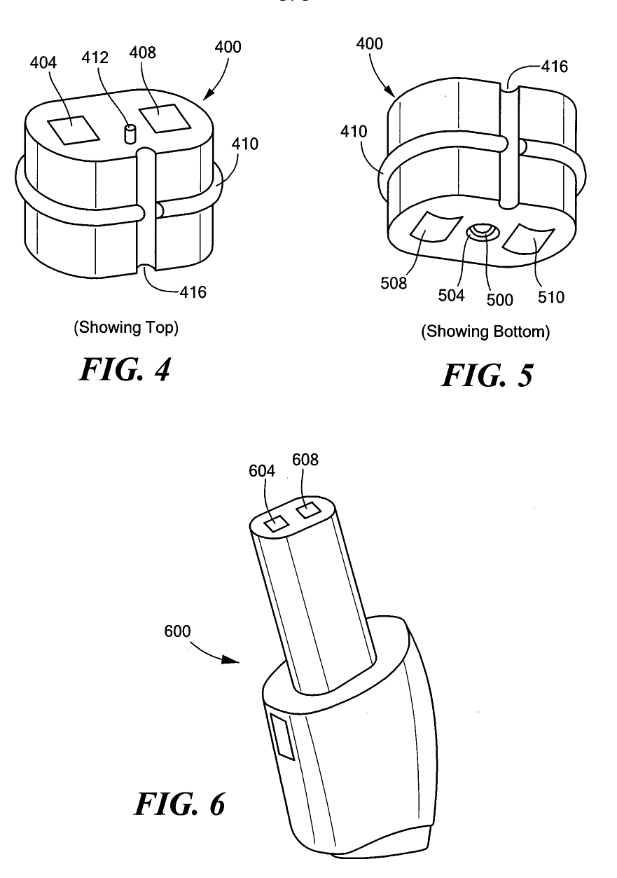

FIGS. 4 and 5 are perspective views showing top and bottom portions, respectively, of a retrofit module 400 that may be used with the device 100 of FIGS. 1 and 3, according to one embodiment of the present invention. The retrofit module 400 may have a form factor similar to the form factor of a top portion 210 (delimited by a dashed line in FIG. 2) of the original main battery assembly 200.

The retrofit module 400 includes a plurality of power supplying terminals, exemplified by terminals 404 and 408, configured to be compatible with the battery terminals of the device 100. The shape of the retrofit module 400 may be somewhat different than the shape of the portion 210 of the original main battery 200, and the retrofit module 400 may have some dimensions larger or smaller than corresponding dimensions of the original main battery 200, as long as the retrofit module 400 fits adjacent the battery terminals of the device 100 and the power supplying terminals make electrical contact with the battery terminals of the device 100.

The retrofit module 400 may include an index boss, groove, ridge or other structure (exemplified by boss 412 or a groove 416) that cooperates with a structure, hole, etc. inside the device handle 104 to ensure proper orientation of the retrofit module 400, relative to the battery terminals of the device 100. An existing structure, hole, contour, etc. inside the device handle 104 may be exploited, or an adapter (not shown) may be permanently or temporarily installed in the device handle 140 to provide a structure, hole, etc. with which the index structure may cooperate.

The retrofit module 400 may included a retaining structure that releasably maintains the power supplying terminals 404 and 408 of the module 400 in contact with the battery terminals of the device 100. In one embodiment, the retrofit module 400 includes a resilient, relatively high-friction band 410 that presses against structures (not shown) inside the handle 104 (FIG. 1) of the device 100, once the retrofit module 400 is installed in the device handle 104, to maintain the retrofit module 400 in place. The retrofit module 400 may include a hook, a loop 500 or another suitable structure, disposed within a recess 504 (also referred to as a “port”) in the bottom of the retrofit module 400, to facilitate removing the retrofit module 400 from the device handle 104 by attaching a cooperating hook or other removal tool and pulling on the loop 500 with sufficient force to overcome the friction between the band 410 and the internal structures of the device handle 104.

In other embodiments, other types of mechanical, magnetic, adhesive or other structures may be used for the retaining structure. In one embodiment, the retrofit module 400 includes an expandable or moveable structure, that, when expanded, moved, turned, etc., presses against or hooks on to a structure in the device handle 104. In other embodiments, a cam, wedge, rotatable eccentric member, hook, catch or other suitable mechanism may be used for the releasable structure. A tool, such as a screwdriver inserted into an access port in the bottom of the retrofit module, may be used to actuate or release the releasable structure.

The retrofit module 400 also includes a plurality of power receiving terminals, exemplified by terminals 508 and 510, configured to be compatible with terminals of a battery or set of batteries (collectively referred to as a battery) that may be hot swapped. The hot-swappable battery need not be configured the same as the original main battery. For example, terminals on the hot-swappable battery need not be compatible with battery terminals of the device. To accommodate such a situation, the power receiving terminals 508 and 510 may be shaped, oriented and/or positioned differently than the battery terminals on the device. That is, the power receiving terminals 508 and 510 may be compatible with the hot-swappable battery, not necessarily with the original main battery. Thus, hot-swappable batteries that would otherwise be incompatible with the device may be used. For example, newly designed batteries having higher capacities or other desirable characteristics may be used.

FIG. 6 is a perspective view of an exemplary hot-swappable battery 600 that may be used with the retrofit module 400. The hot-swappable battery 600 is similar in shape to the original main battery 200 (FIG. 2), except, in this embodiment, the hot-swappable battery 600 is smaller. The hot-swappable battery 600 may be an off-the-shelf battery or a custom-designed battery.

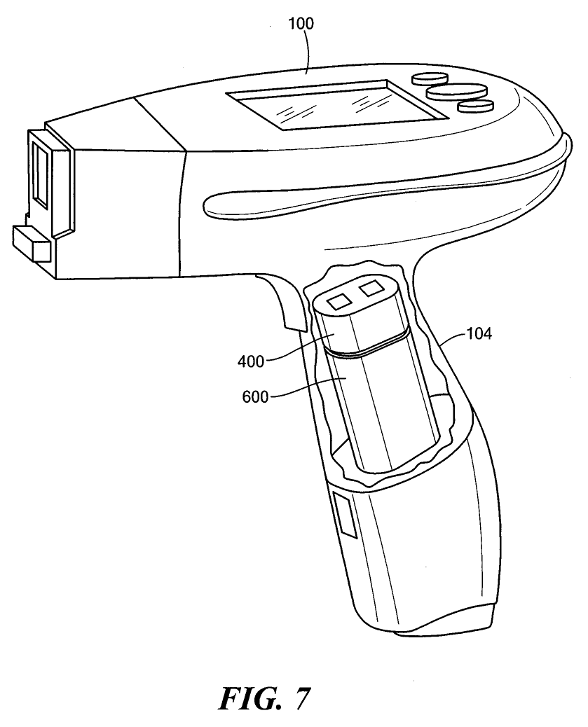

The power receiving terminals 508 and 510 of the retrofit module 400 may be resilient metal contacts, against which terminals 604 and 608 of the hot-swappable battery 600 are pressed, when the hot-swappable battery 600 is inserted into the handle 104 of the device 100, as exemplified in FIG. 7.

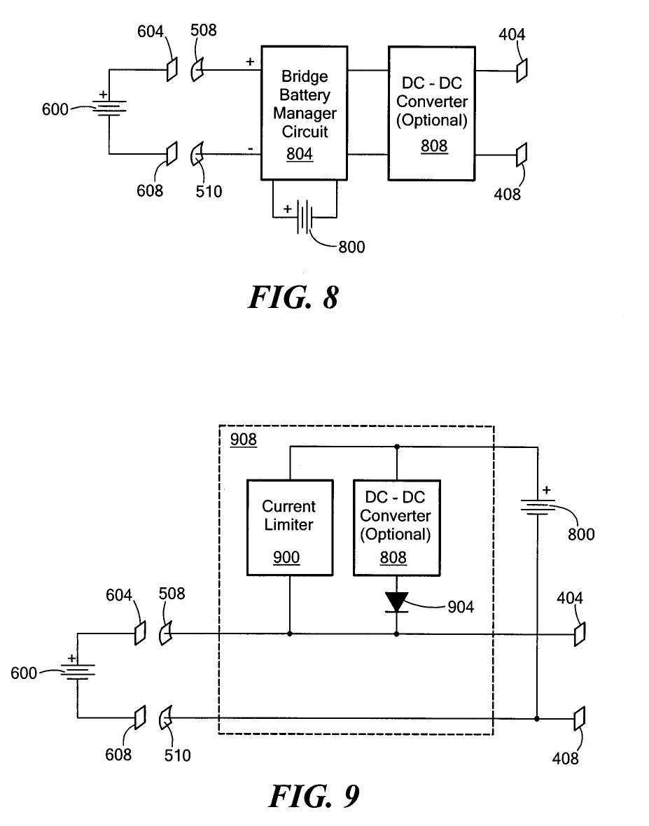

FIG. 8 is a schematic block diagram of a circuit in the retrofit module 400. The circuit includes a bridge battery 800 and a bridge battery manager circuit 804. The bridge battery manager circuit 804 controls whether the device 100 is powered (via the power supplying terminals 404 and 408) by the hot-swappable battery 600 or by the bridge battery 800. The bridge battery manager circuit 804 provides automatic switchover from the hot-swappable battery 600 to the bridge battery 800 when the hot-swappable battery 600 is disconnected from the power receiving terminals 508 and 510 or, optionally or alternatively, when the charge remaining in the hot-swappable battery 600 falls below a predetermined level. Optionally or alternatively, a switch (not shown) that is mechanically operated when the hot-swappable battery 600 is installed or removed from the device 100 may be connected to the bridge battery manager circuit 804 to trigger switchover between the hot-swappable battery 600 and the bridge battery 800, such as by simulating disconnection of the hot-swappable battery 600 from the power receiving terminals 508 and 510.

The bridge battery manager circuit 804 causes the bridge battery 800 to be recharged from the hot-swappable battery 600, when the hot-swappable battery 600 is connected and has a sufficient amount of charge remaining. The bridge battery manager circuit 804 may include a control circuit to prevent over-charging the bridge battery 800, such as by simulating disconnection of the hot-swappable battery 600 from the power receiving terminals 508 and 510.

The bridge battery manager circuit 804 may include a boost converter (not shown) to increase the voltage provided by the bridge battery 800 to a value required by the device 100, thus reducing the number of cells required for, and thus the physical size of, the bridge battery 800. Optionally, the circuit may include a separate step-up DC-DC converter 808 to perform this function.

The bridge battery manager circuit 804 and the DC-DC converter 808 may be discrete, integrated or hybrid circuits. Suitable integrated circuits for use in or as bridge battery manager circuits are available under part number LTC1558 from Linear Technology Corporation, Milpitas, Calif. or under part number MAX1612 or MAX1613 from Maxim Integrated Products, Inc., Sunnyvale, Calif. A suitable integrated circuit for use in or as a DC-DC converter circuit is available under part number MAX1630 from Maxim Integrated Products, Inc. or under part number LPQ Series from Wall Industries, Inc., Exeter, N.H.

FIG. 9 is a schematic block diagram of another embodiment of a circuit in the retrofit module 400. A current limiter 900 limits charge current flowing into the bridge battery 800. A diode 904 allows current to flow from the bridge battery 800 to the device 100, via the power supplying terminals 404 and 408, when the hot-swappable battery 600 becomes discharged or is disconnected from the circuit. An “ideal diode” integrated circuit may be used for the diode 904. A suitable ideal diode integrated circuit is available under part number LTC4411 from Linear Technology Corporation, Milpitas, Calif. An optional step-up DC-DC converter may be used to step up the voltage of the bridge battery 800, if desired. The circuit within the dashed box 908 may essentially perform the functions of the bridge battery manager circuit 804 of FIG. 8.

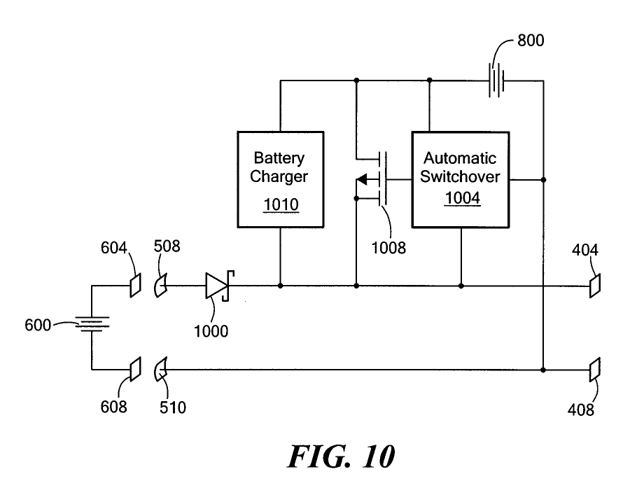

If the current requirements of the device 100 are greater than the amount of current that can be provided by an integrated circuit bridge battery manager, an automated switchover integrated circuit may be used to control another component, such as a P-channel MOSFET, for power switching, as shown in a schematic diagram in FIG. 10. A power Schottky diode 1000 prevents back-feeding the hot-swappable battery 600. A automatic switchover component 1004 controls a P-channel MOSFET 1008, and a battery charger integrated circuit 1010 controls charging the bridge battery 800. A suitable automatic switchover component is available under part number LTC4414, and a suitable battery charger is available under part number LTC4053, from Linear Technology Corporation, Milpitas, Calif. A suitable P-channel MOSFET is available under part number SUP75P03-07 from Vishay Intertechnology, Inc., Malvern, Pa. A suitable power Schottky diode is available under part number UPS840 from Microsemi Corporation, Irvine, Calif.

Other suitable integrated circuits for various functions include those available under part numbers LTC4357, LTC4416, and/or LTC3455, which are available from Linear Technology Corporation, Milpitas, Calif.

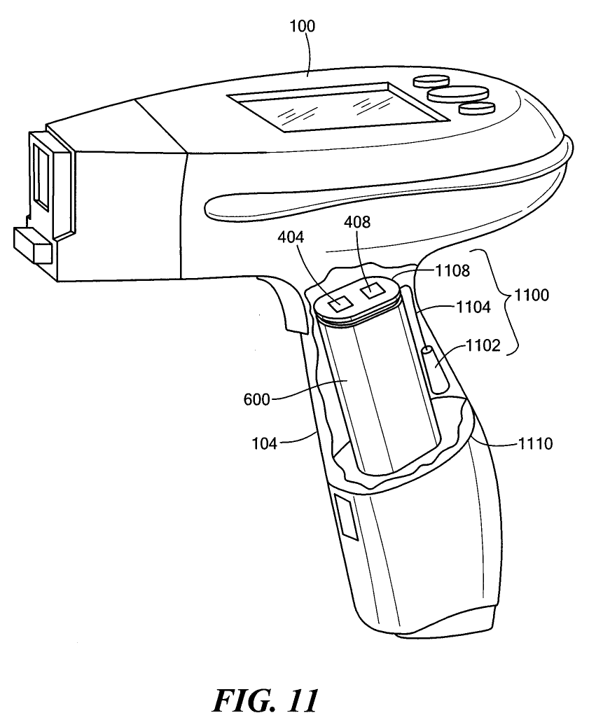

FIG. 11 is a perspective view of another embodiment of a retrofit module 1100, in which the bridge battery and all or part of the circuit is disposed in a housing 1102 that is separated from the power supplying terminals 404 and 408 and the power receiving terminals (not visible) by a cable 1104. The housing 1100 may be placed temporarily or permanently, loose or fixed in position (such as by an adhesive or a hook-and-pile retainer), in any suitable cavity or place within or outside the device 100. The cable 1104 may be thin enough to extend through an existing opening in the case of the device 100, through a gap along the boundary 1110 between the case or handle 104 of the device 100 and the hot-swappable battery 600, through an opening created specifically to accommodate the cable 1104 or through another suitable opening or gap.

The power supplying terminals 404 and 408 and the power receiving terminals may be disposed on a thin substrate 1108. In some embodiments, the substrate 1108 is thin enough that the original main battery 200 may be used for the hot-swappable battery 600, thereby eliminating the need to use a smaller hot-swappable battery. The substrate 1108 may be urged toward the battery terminals (not visible) by the hot-swappable battery 600, so the power providing terminals 404 and 408 make contact with the battery terminals (not shown) of the device. Optionally or alternatively, the substrate 1108 may be fixed in place by an adhesive (such as a conductive adhesive between respective power supplying terminals 404 and 408 and battery terminals of the device) or a mechanical interlock with a structure (not shown) within the device handle 104.

Some embodiments of the retrofit module may be used with self-contained, hand-held XRF analyzers, such as a model XL3t XRF analyzer available from Thermo Fisher Scientific NITON Analyzers, Billerica, Mass. The model XL3t analyzer normally draws about 1.5 A from a 7.5V battery, i.e., about 11.25 watts, while it is on but its trigger is not actuated, i.e., while its x-ray tube is not generating x-rays. One watt equals one joule per second. Assuming about 15 seconds are required to replace a battery in this analyzer, about 169 joules of energy (15 seconds×11.25 joules/second) are consumed during a battery swap. Thus, a bridge battery capable of storing and providing at least about 195 joules should be used to provide sufficient energy to operate the analyzer during a battery swap, taking into account expected inefficiencies in control circuits, etc. A typical small lithium ion rechargeable battery rated at 0.75 Ahr at 3.7V stores about 10,000 joules, which should be sufficient to operate an XL3t analyzer during a battery swap. If high bridge battery discharge current is required, a nanotechnology lithium ion battery may be used. Suitable nanotechnology lithium ion batteries are available from A123Systems Energy Solutions Group, Hopkinton, Mass.

Although retrofit modules have been described as including bridge batteries, other energy storage devices may be used, depending on energy storage requirements and discharge characteristic requirements. In some embodiments, one or more capacitors, such as so-called supercapacitors or ultracapacitors, may be used in place of, or in addition to, rechargeable batteries. For example, a 10 F capacitor (such as two 20 F capacitors in series) charged to 7.5V stores about 281 joules (½×CV²). During discharge of a capacitor, the voltage across the capacitor drops. Thus, a suitable DC-DC converter should be used, as described above.

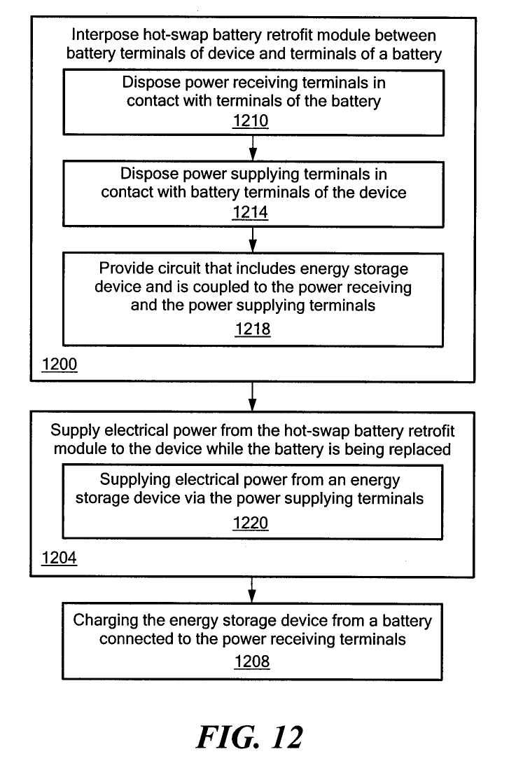

FIG. 12 is a flowchart that illustrates operations that may be performed to provide temporary electrical power to a device while a battery is replaced. At 1200, a hot-swap battery retrofit module is interposed between battery terminals of the device and terminals of a battery. The module may be interposed such that at least one of the terminals of the battery is not in physical and direct electrical contact with any battery terminal of the device. Thus, the module can isolate the battery from the device to prevent current from flowing from the battery to the device.

This operation may involve disposing a plurality of power receiving terminals in contact with terminals of the battery, as shown at 1210. In addition, a plurality of power supplying terminals may be disposed such that the power supplying terminals are in physical and direct electrical contact with the battery terminals of the device, as shown at 1214. Furthermore, as shown at 1218, a circuit that includes an energy storage device and that is coupled to the power receiving terminals and to the power supplying terminals may be provided.

As shown at 1204, electrical power is supplied from the hot-swap batter retrofit module to the battery terminals of the device while the battery is begin replaced. This may involve supplying the electrical power from the energy storage device via the power supplying terminals, as shown in 1220. Optionally, as shown in 1208, the energy storage device may be charged from a battery connected to the power receiving terminals.

In accordance with exemplary embodiments, described herein, a module is provided for retrofitting a battery-powered device for operation with a hot-swappable battery. While specific values chosen for these embodiments are recited, it is to be understood that, within the scope of the invention, the values of all of parameters may vary over wide ranges to suit different applications. For example, although embodiments employing two battery terminals, two power receiving terminals and two power supplying terminals are described, in other embodiments other numbers of terminals may be used. For example, using three terminals, two different voltages or two isolated voltage sources may be provided.

Although use of the above-described retrofit module has been described in the context of a device that does not, by itself, include a battery hot-swap capability, the retrofit module may be used with devices that include their own built-in hot-swap capability. Such a use of a retrofit module may be advantageous, for example, after a built-in hot-swap circuit or a built-in bridge battery has failed or for fail-safe operation while a main battery is swapped.

While the invention is described through the above-described exemplary embodiments, it will be understood by those of ordinary skill in the art that modifications to, and variations of, the illustrated embodiments may be made without departing from the inventive concepts disclosed herein. For example, although a retrofit module has been described with reference to hand-held test or analytical instruments, a retrofit module may be used with any battery-powered device, such as a laptop computer, toxic gas warning device, flashlight, or the like. Furthermore, disclosed aspects, or portions of these aspects, may be combined in ways not listed above. Accordingly, the invention should not be viewed as being limited to the disclosed embodiments.

What is claimed is:

1. A hot-swap battery retrofit module for connection to battery terminals of a device, the device's battery terminals being compatible with terminals on a first battery, the module comprising:
a plurality of electric power receiving terminals compatible with terminals on a second battery;
a plurality of electric power supplying terminals compatible with the battery terminals of the device;
an energy storage device; and
a circuit connected to the energy storage device, the power receiving terminals and the power supplying terminals, such that:
in a first mode, the power receiving terminals are coupled to the power supplying terminals; and
in a second mode, the energy storage device is coupled to the power supplying terminals.

2. A hot-swap battery retrofit module according to claim 1, wherein the terminals on the first battery are configured in substantially the same manner as the terminals on the second battery.

3. A hot-swap battery retrofit module according to claim 1, wherein the circuit is configured to charge the energy storage device from power available via the power receiving terminals.

4. A hot-swap battery retrofit module according to claim 1, wherein:
in the first mode, a battery is coupled to the power receiving terminals; and
in the second mode no battery is coupled to the power receiving terminals.

5. A hot-swap battery retrofit module according to claim 1, wherein:
in the first mode, a battery having at least a predetermined level of charge is coupled to the power receiving terminals; and
in the second mode no battery, or a battery having less than the predetermined level of charge, is coupled to the power receiving terminals.

6. A hot-swap battery retrofit module according to claim 1, wherein at least a portion of the retrofit module has a form factor based on at least a portion of a form factor of the first battery.

7. A hot-swap battery retrofit module according to claim 1, further comprising:
a substrate on which the plurality of electric power receiving terminals and the plurality of electric power supplying terminals are disposed;
a housing separate from the substrate and in which the circuit is disposed; and
a cable connecting the circuit to the power receiving terminals and to the power supplying terminals.

8. A hot-swap battery retrofit module according to claim 1, further comprising a retaining structure configured to releasably maintain at least the power supplying terminals of the module in contact with the battery terminals of the device, absent a battery coupled to the power receiving terminals.

9. A hot-swap battery retrofit module according to claim 8, wherein the retaining structure comprises a resilient friction material proximate at least a portion of a surface of the retrofit module.

10. A hot-swap battery retrofit module according to claim 8, wherein the retaining structure comprises an expandable structure.

11. A hot-swap battery retrofit module according to claim 8, wherein the retaining structure comprises a structure capable of at least partial rotation.

12. A hot-swap battery retrofit module according to claim 8, further comprising a port configured to accept a removal tool.

13. A hot-swap battery retrofit module according to claim 1, further comprising a retaining structure configured to maintain the module in contact with the device's battery terminals.

14. A hot-swap battery retrofit module according to claim 1, further comprising an index structure that cooperates with a structure of the device to limit orientation of the retrofit module.

15. A hot-swap battery retrofit module according to claim 14, wherein the index structure comprises a boss.

16. A hot-swap battery retrofit module according to claim 14, wherein the index structure comprises a ridge.

17. A hot-swap battery retrofit module according to claim 14, wherein the index structure defines a groove.

18. A hot-swap battery retrofit module according to claim 1, wherein the energy storage device comprises a rechargeable battery.

19. A hot-swap battery retrofit module according to claim 1, wherein the energy storage device comprises a capacitor.

20. A method for providing temporary electrical power to a device while a battery is replaced, the method comprising:
interposing a hot-swap battery retrofit module between battery terminals of the device and terminals on the battery, such that at least one of the terminals of the battery is not in physical and direct electrical contact with any battery terminal of the device; and
supplying electrical power from the hot-swap battery retrofit module to the battery terminals of the device while the battery is being replaced.

21. A method according to claim 20, wherein:
interposing the hot-swap battery retrofit module comprises:
disposing a plurality of power receiving terminals in physical and direct electrical contact with the terminals on the battery;
disposing a plurality of power supplying terminals in physical and direct electrical contact with the battery terminals of the device; and
providing a circuit that includes an energy storage device and that is coupled to the power receiving and power supplying terminals; and
supplying the electrical power while the battery is being replaced comprises supplying electrical power from the energy storage device via the power supplying terminals.

22. A method according to claim 21, further comprising charging the energy storage device from a battery connected to the power receiving terminals.
